(19) United States
(12) Patent Application Publication
(10) Pub. No.: US 2021/0125744 A1
(43) Pub. Date: Apr. 29, 2021

(54) TRANSMISSION CABLE

(71) Applicant: James Cheng Lee, La Habra, CA (US)

(72) Inventor: James Cheng Lee, La Habra, CA (US)

(21) Appl. No.: 16/863,035

(22) Filed: Apr. 30, 2020

Related U.S. Application Data
(60) Provisional application No. 62/925,760, filed on Oct. 24, 2019.

(30) Foreign Application Priority Data
Apr. 23, 2020 (CN) 202010325980.8

(51) Int. Cl. H01B 7/02; H01B 7/04

(52) U.S. Cl. CPC H01B 7/0216; H01B 7/0258; H01B 7/0241; H01B 7/04

(57) ABSTRACT

A transmission cable provided includes a conductor, a protective layer, and a wrapping layer. The protective layer covers the conductor. The wrapping layer surrounds the protective layer. The protective layer covers the conductor to increase a bending strength of the transmission cable.

### BACKGROUND OF THE INVENTION

### 1. Field of the Invention

The present invention relates to a cable, and particularly to a cable for high speed/frequency transmission.

### 2. The Prior Arts

Regarding to the cable manufactured currently, an insulation layer is directly pressed out on the conductor to achieve the effect of protection and insulation. As shown in FIG. 1, a conductor 10 in a transmission cable 1 is covered with an insulation layer 11. However, a dielectric constant of the insulation layer has a great influence on the performance of high frequency/speed transmission, so foam materials are usually used to reduce the dielectric constant, but the foam materials are not easy to meet the standard of distribution and yield in a manufacturing process, and an outer diameter of the foam material is relatively large, which limits the selectable size of mechanism.

Therefore, the wrapping process is used to improve the above problems, the transmission loss of the cable produced by the wrapping process is lower than that of the foaming process at high frequency/speed, but mechanical properties the bending resistance, tensile strength and elongation of the wrapped cable are insufficient, thus the wrapped cable is easy to be bent during cable management and the manufacturing process, which causes the core to break and reduces the yield.

Therefore, it is needed to provide a cable structure that can improve bending resistance, tensile strength, and elongation.

### SUMMARY OF THE INVENTION

To solve the aforementioned problems, a transmission cable is provided and includes a conductor, a protective layer, and a wrapping layer. The protective layer covers the conductor. The wrapping layer surrounds the protective layer. The protective layer covers the conductor to increase the bending strength of the transmission cable.

In an embodiment, the conductor is made of multiple strands.

In an embodiment, the conductor is made of metal or alloy.

In an embodiment, the protective layer includes a pressure-resistant material including a high molecular polymer, an organic additive, or an inorganic additive.

In an embodiment, the wrapping layer is composed of insulation material.

In an embodiment, the protective layer covers the conductor along a longitudinal direction.

In an embodiment, the protective layer covers the conductor by wrapping.

In an embodiment, the protective layer covers the conductor by pressing.

In an embodiment, the protective layer covers the conductor by plating.

In an embodiment, the wrapping layer surrounds the protective layer by wrapping.

The present invention increases the bending strength of the proposed transmission cable by covering a protective layer on the conductor before wrapping. In addition, the protective layer can make the wrapping tighter to improve the insulation and anti-interference effect. In this way, the electrical instability under the wrapping condition of the prior art can be improved, and the mechanical strength can also be improved.

Those having ordinary skill in the art will understand that the effects achieved through the disclosure of the present invention are not limited to those specifically described above, and advantages of the present invention will be more clearly understood from the above detailed description in conjunction with the drawings.

### BRIEF DESCRIPTION OF THE DRAWINGS

FIG. 1 illustrates a transmission cable manufactured through wrapping technology of the prior art.

FIG. 2 illustrates a transmission cable according to an embodiment of the present invention.

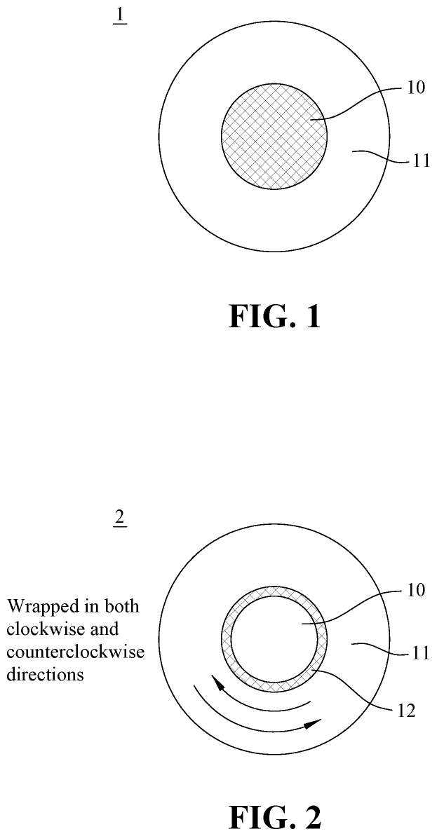

### DETAILED DESCRIPTION OF THE PREFERRED EMBODIMENT

Please refer to FIG. 2. FIG. 2 illustrates a transmission cable according to an embodiment of the present invention. The transmission cable 2 includes a conductor 10, a protective layer 12, and a wrapping layer 11 sequentially from inside to outside. The conductor 10 may be composed of a metal or an alloy, for example, formed by stranding copper wires. Preferably, the protective layer 12, formed by means of polypropylene(PP), polyethylene(PE), polytetrafluoroethylene(PTFE), polyfluoroalkoxy(PFA), fluorinated ethylenepropylene(FEP) and plating, etc., can be composed of single-layer or multi-layer polymers, organic or inorganic additives, pressure-resistant materials and other materials that can withstand torsional stretching and are coated on the conductor 10. The protective layer 12 may be covered by covering the conductor along a longitudinal direction, wrapping the conductor to cover the conductor, mixing various materials to be pressed out to cover the conductor, and covering the conductor by plating so as to avoid fatigue and breakage of the transmission cable 2 due to the torsional tension accumulated usage.

Then, a wrapping layer 11 surrounded by the protective layer 12 is composed of an insulation material. The wrapping layer 11 being placed vertically or rolled up can be wrapped on the protective layer 12.

The protective layer 12 mentioned above may be wrapped around the conductor 10 in a clockwise and counterclockwise direction. In this way, when the transmission cable 2 is rotated clockwise/counterclockwise, the protective layer 12 wrapping around clockwise/counterclockwise can further protect the conductor 10 by reverse winding, and limiting the rotational deformation to avoid cable breakage.

In addition, a buffer section can also be added at an intersection of the above-mentioned clockwise and counterclockwise windings to increase the extendable length to avoid breaking due to the tensile force caused by bending.

The transmission cable proposed by the present invention increases the bending strength by covering a protective layer on the conductor before wrapping. In addition, the interlaced winding of the protective layer can make the wrapping tighter, increase resistance to torsional stretching and improve insulation and anti-interference effect. In this way, the electrical instability under the wrapping condition of the prior art can be reduced and the mechanical strength can be increased.

It is obvious to a person having ordinary knowledge in the technical field that the present invention can be implemented in other specific forms without departing from the spirit of the present invention. Therefore, the above description should not be understood as limiting but illustrative in all respects.

The scope of the present invention should be determined by a reasonable explanation of the scope of the present invention, and all variations within the scope of equivalents of the present invention are included in the scope of the present invention.

1. A transmission cable comprising:
a conductor;
a protective layer covering the conductor, the protective layer being formed of at least one material selected from the group consisting of polypropylene, polyethylene, polytetrafluoroethylene, polyfluoroalkoxy, and fluorinated ethylenepropylene, and having one part wrapping around the conductor in a clockwise direction and another part wrapping around the conductor in a counterclockwise direction; and
a wrapping layer surrounding the protective layer;
wherein the protective layer covers the conductor to increase a bending strength of the transmission cable.

2. The transmission cable of claim 1, wherein the conductor is made of multiple strands.

3. The transmission cable of claim 1, wherein the conductor is made of metal or alloy.

4. The transmission cable of claim 1, wherein the protective layer includes a pressure-resistant material including a high molecular polymer, an organic additive, or an inorganic additive.

5. The transmission cable of claim 1, wherein the wrapping layer is composed of insulation material.

6. The transmission cable of claim 1, wherein the protective layer covers the conductor along a longitudinal direction.

7. The transmission cable of claim 1, wherein the protective layer covers the conductor by wrapping.

8. The transmission cable of claim 1, wherein the protective layer covers the conductor by pressing.

9. The transmission cable of claim 1, wherein the protective layer covers the conductor by coating.

10. The transmission cable of claim 1, wherein the wrapping layer surrounds the protective layer by wrapping.
